(19) United States
(12) Patent Application Publication
(10) Pub. No.: US 2003/0229812 A1
(43) Pub. Date: Dec. 11, 2003

(54) Authorization mechanism

(76) Inventor: Cristina Buchholz, Walldorf (DE)

Correspondence Address: FISH & RICHARDSON, P.C., 3300 DAIN RAUSCHER PLAZA, 60 SOUTH SIXTH STREET, MINNEAPOLIS, MN, 55402, US

(21) Appl. No.: 10/372,030

(22) Filed: Feb. 21, 2003

Related U.S. Application Data
(60) Provisional application No. 60/386,839, filed on Jun. 5, 2002.

(51) Int. Cl. H04L 9/32; H04L 9/00

(52) U.S. Cl. 713/202; 713/201

(57) ABSTRACT

A central authorization mechanism allows an employee of one company to use computing resources of another company based on a mapping of the user's role in one company to a corresponding role in another company based on equivalence of respective privileges associated with the roles.

### CROSS-REFERENCE TO RELATED APPLICATIONS

This application claims priority to provisional U.S. Application Serial No. 60/386,839, filed on Jun. 5, 2002 by Sachar Paulus and Tom Schroer, entitled “e-Business Security Architecture.” The present application is also related to a companion application entitled “Collaborative Audit Framework,” filed by Sachar Paulus, Tom Shroer and Cristina Buchholz, (attorney docket No. 13913-037001) on the same day as this application, which companion application in its entirety is incorporated by reference herein.

### TECHNICAL FIELD

This invention relates to information technology security, and more particularly to authorization management.

### BACKGROUND

The working environment of e-business is characterized by open networks and cross-company business transactions, replacing closed and monolithic systems. In this environment, secure data access is a central aspect of doing business.

Within a single application in a single enterprise a security domain can easily be maintained so that a registry of access authorizations is available for each user. Once authenticated by ID and password, e.g., the authorization can be read directly from the registry and access to a requested resource, e.g., a document or database, can be granted or denied. The authorizations can be added, modified or revoked via such a registry. In distributed computing environments having a collection of different applications, a central repository of such authorizations associated with users can facilitate the authorization process. The problem grows considerably more complex however, when collaborative business requires access by users from one company A to the protected resources of company B.

Existing solutions for user management suffer from a common problem: they are tailored to particular applications. Every system to be included in a company landscape requires the user management tool to create yet another adaptor. In most cases, the connection to a central user management tool also requires a plug-in to be installed in the software to be connected. The user and role information is centrally kept. In most cases this involves redundant storage because the information has to be prepared for every connected system.

### SUMMARY

The invention provides the framework for a collaborative, policy-based, application-independent authorization management system, providing a path for evolution of user management systems from proprietary, application-specific solutions that contain only high-level role information to central generic authorization repositories that offer not only role data, but also detailed, ready-to-use authorization information.

A collaborative authorization process, according to one aspect of the invention, provides for mapping a set of roles in one enterprise onto a set of roles in another enterprise according to the equivalence of their respective privileges, to establish a uniform role-mapping from one enterprise to the another. When a user in one enterprise applies for authorization to gain access to a resource in the other enterprise, the user's role in said one enterprise is identified and, using the pre-existing role-mapping, the corresponding role with corresponding privileges in the other enterprise is ascertained. Based on the privileges conferred on the corresponding role in the other enterprise, the user is granted or denied access to the resource.

According to one aspect of the invention, a collaborative authorization process comprises defining a set of privileges in a first system, establishing a mapping of each said set of privileges to corresponding roles in a second system, and automatically granting access to a user according to privileges associated with the roles in the second system to which the user's set of privileges in the first system maps. The systems can be in different enterprises.

A collaborative authorization process according to another aspect of the invention, comprises defining a set of roles in a first system (e.g., a first enterprise), identifying a set of privileges corresponding to each of said roles in the first system, establishing a mapping of each role to corresponding privileges in a second system (e.g., a distinct second enterprise under separate ownership), and at runtime automatically granting access to a user according to privileges in the second system to which the user's role in the first system maps. If the first and second systems are located within different enterprises, then there is a mapping of roles to privileges between enterprises. The mapping is equivalent to the statement: “Users with role A for company A have the privileges of role B for company B.” This mapping might be further passed on: “Users with role A for A and role B for B have role C for C.” The framework thus opens the context of the user from his or her original company/authorization system.

In order have a role mapping; the privileges in the second system are aggregated in roles, so that by mapping each role in the first system to corresponding privileges in a second system, roles in the first system are mapped to corresponding roles in the second system.

A directory can be maintained to correlate the user ID with his or her role and/or privileges in the first system so that it can be mapped to the corresponding privileges and role of the second system.

The system relies on decomposition of roles into component privileges and matching privileges between trust domains based on identity and equivalence.

The same system can be used to manage role consolidation in a merger or acquisition, and also to rationalize the various roles and privileges based on implicit relationships among the privileges.

Using the present invention, applications will be able to use information supplied by the central user repositories without additional processing or checking, eliminating the need for sophisticated user management functions within individual business applications.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a diagram of circles of trust between two enterprises.

FIG. 2 is a block diagram of role mapping between two enterprises according to the invention.

FIG. 3 is a diagram of policy server architecture.

FIG. 4 is a diagram of a policy server executing company wide policy management.

FIG. 5 is a diagram illustrating transparent access.

FIG. 6 is a diagram illustrating inconsistent role management via the policy server.

FIG. 7 is a diagram of role mining.

FIG. 8 is a diagram illustrating external coordination by means of a central policy server.

FIG. 9 is a diagram illustrating external mapping and projection by means of a central policy server.

FIG. 10 is a diagram illustrating management of merging and consolidation by means of a central policy server.

FIG. 11 is a diagram illustrating differentiation and context provided by means of a central policy server.

FIG. 12 is a diagram illustrating separation of authority by means of a central policy server.

Like reference symbols in the various drawings indicate like elements.

### DETAILED DESCRIPTION

Introduction In the classical architecture, two levels of integration, namely integration at user level and integration at process level, are both realized within the application server, as part of its proprietary architecture.

In SAP R/3 systems, for example, user integration was realized using the profile, and later, the role concept. This allowed multiple scenarios to be grouped around one “user”.

Process integration, on the other hand, happened within the source code of an application. For example, if an SD transaction needed to execute an Fl transaction, then the developer would use the “call transaction” statement to realize the integration.

To connect to external Internet technologies, these systems used additional components. On the user side this could be the SAP Internet Transaction Server, and on the process side, the SAP Business Connector.

The main component, the “server”, could be protected to some extent by placing firewalls around it.

In a Web-service world, where the assumption is that people and processes should be able to work together seamlessly, the paradigm is different.

To realize thin Web services in such a way that they can be integrated seamlessly, the integration components are taken out of the application. Both user and process integration now take place in dedicated components:

One uses a portal for people-centric integration, and

The other uses an exchange infrastructure for process-centric integration

An initial outcome of this change is that placing firewalls between these components no longer makes much sense (aside from closing up gaps in the operating system), because each of the components now carries valuable business information. So other technologies to protect this data need to be developed.

A first consequence of removing user integration is to begin to take away all user management from the applications. And since they no longer carry integration knowledge about users, there is no need to keep user information there. Information about people instead becomes part of the individual business objects. To exchange users between different trust domains, the concept of federated identities is currently being developed.

The implication of this shift is that there is also no longer any authorization administration within applications. This change makes sense since authorizations can then be given to users in the portal framework on a business basis (and the application works with these values) instead of following the rules offered by the application for assigning rights to users.

But the application still has to check the validity of a request. This is handled by new protocols for exchanging credentials, known as assertion handling protocols, such as the Security Assertion Markup Language (SAML), for example.

Removing process integration has a similar impact. First of all, the communication between different services no longer takes place within one closed system. So this communication has to be protected against manipulation, eavesdropping, and so on. Web Services Security Extensions provide a standardized framework for applying encryption and digital signatures to Simple Object Access Protocol (SOAP) requests.

Secondly, the knowledge of a company's processes moves from the application server to the exchange infrastructure. This knowledge is crucial for a company's assets, and this component therefore has to be highly secured.

Finally, processes must be audited at some point in time, for legal or financial reasons. But since processes in a Web-services world are distributed by their nature, auditing becomes largely impossible. Consequently, a framework for tracking processes across a broad landscape is needed.

All of these new requirements show that it is no longer sufficient to rely on a perimeter type of security to protect your company's assets.

Web services provide a way of linking applications not only within an enterprise, but also across company boundaries.

The connections are loosely coupled, and language- and platform-neutral, which allows greater flexibility in collaborating with customers and partners.

However, it also means that such security functions as managing users and trust purely within an enterprise, or providing non-repudiation information using digital signatures, are no longer sufficient and need to be enhanced by Web-service security features that transcend the boundaries of the closed enterprise IT environment.

The new security models that are needed can be added to existing functionality, to protect investments as business processes are turned into Web services.

The main task of these new models is to secure the integrity and confidentiality of messages sent via SOAP, and to ensure that the services that are called act only if the request is properly authorized and can provide proof of this authorization.

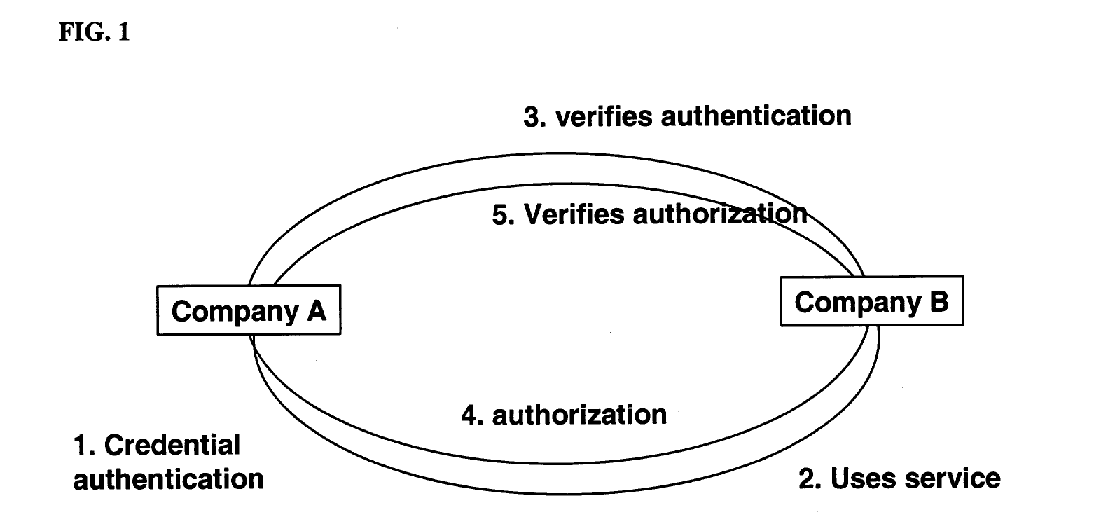

As shown in FIG. 1, secure access by one company A to the other company B's protected resources involves circles of trust taking the form of the following sequence of steps:

1. credential authentication;

2. uses service;

3. verifies authentication;

4. authorization; and

5. verifies authorization.

The framework of the present invention is the solution for the steps 4 and 5, authorization mapping and verification. With state of the art systems, there are two possible ways to react: either the companies A and B have agreed on authorization equivalence—which is a manual, verbal or contractual process, error-prone because of possible subsequent changes in the authorization/role definition. Or the user is mapped onto an anonymous user with limited access rights.

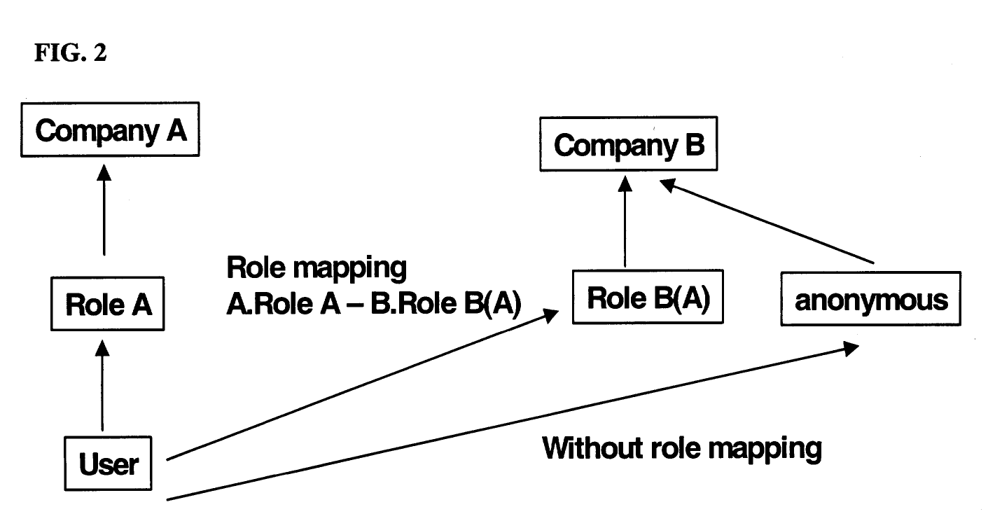

The framework opens the context of the user from their original company/authorization system. As illustrated in FIG. 2, the authorization mapping is equivalent to the statement:

“Users with role A for company A have the privileges of role B for company B.” This mapping might be further passed on: “Users with role A for A and role B for B have role C for C.”

Prerequisites

The prerequisite for the role mapping as described, is the definition of a role equivalence based on a common description.

Role A means for A privileges a1, a2, a3

Role B means for B privileges b1, b2

For every user u of company A, if u has the role A (implicitly the privileges a1, a2, a3) then the user should be allotted privileges b1 and b2 of role B for company B.

The proposed solution for realizing this is a decomposition of roles in building blocks—which are the privileges. The building blocks are then:

used to build a role

A.roleA is composed of A.a1, A.a2 and A.a3

mirrored for finding correspondences in a business context (role mapping)

A.a1 mirrors to B.b1

analyzed for equivalence (merging and acquisition)

A.a1 is equivalent to B.a1

analyzed and composed to find the most general elements (role mining)

A.a1 and A.a2 is equivalent to A.a3

Implementation Steps

In order to implement the described authorization mapping system, the following steps need to occur:

A. Define a common vocabulary of building blocks:

access to resource (e.g., invoice)

parameters (e.g., up to 10 k $)

B. Define a representation of the roles based on their composition (e.g., UDDI or WSDL (Web Service Definition Language) for roles)

C. Define rules of equivalence and mapping

D. Implement prototype. Define the rules, implement an expert system for handling, implement the company policy with the expert system, and create a business relationship scenario.

Transitions Paths for Existing Authorization

Systems to the Collaborative Authorization Framework

Path 1

The applications define authorization objects. During run-time, they call the verification function for access to the authorization objects. The authorization objects are published to the policy server. The authority check takes place on the policy server.

Path 2

The applications call the verification function. The policy server checks the authorization. If granted, the authority check is called in the application. This might be a good transition solution for existing applications.

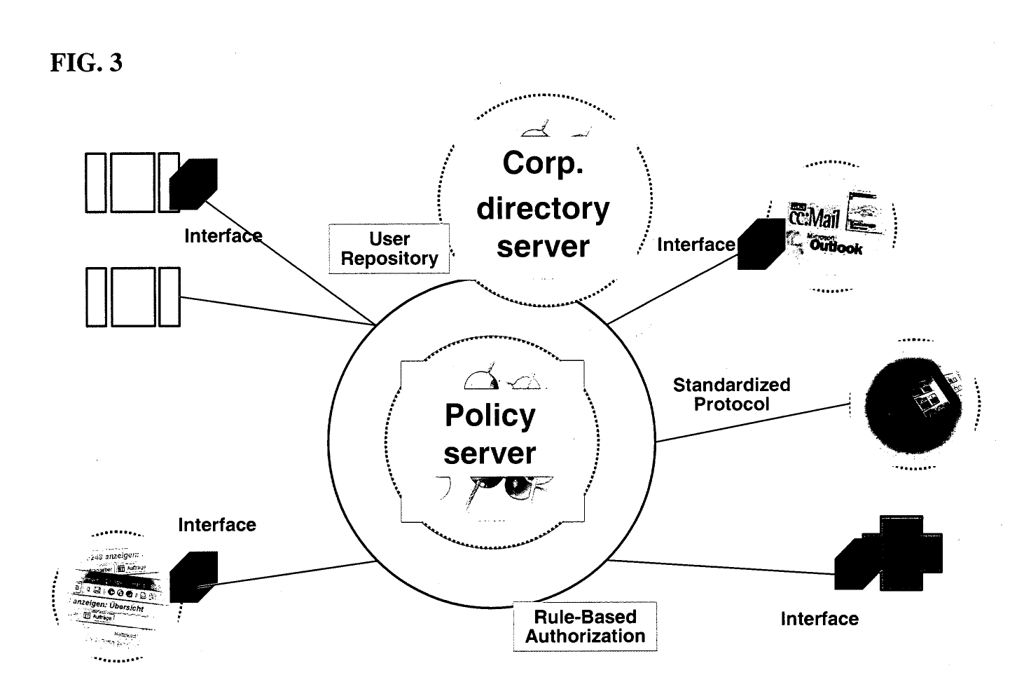

As shown in FIG. 3, the architecture of one possible model on which the role mapping system can be implemented is the Policy server model. The policy server is the central component, responsible for all authorization administration and for delivering the authorization information to connected components on request.

The policy server implements the company authorization policy based on rules. Including an expert system in the server, we can also achieve further gals, e.g. role mining, role consolidation after merging or acquisition of other systems.

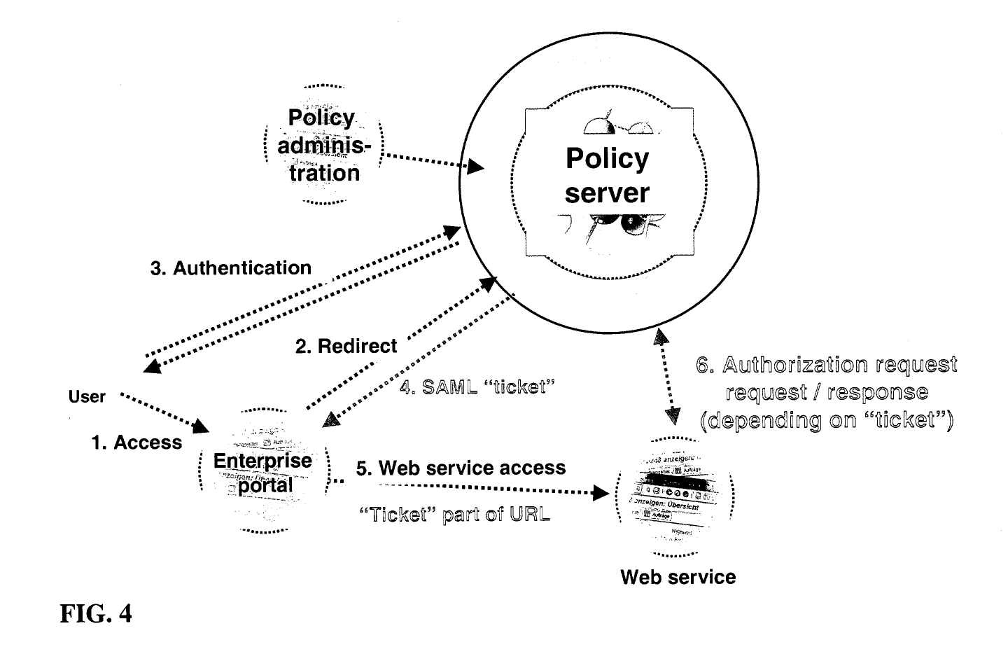

One such scenario is illustrated in FIG. 4.

First, the user accesses the enterprise portal.

The enterprise portal redirects the request to the policy server, which authenticates the user directly and, if successful, returns a ticket to the enterprise portal.

This ticket forms part of the URL needed to access the Web service. If the assertion itself is contained within the ticket, no further authorization is required. However, if the ticket contains a reference number, the Web service sends an authorization request to the policy server.

There are three basic types of assertions:

authentication assertions, containing users, which are used at present;

attribute assertions, containing roles; and

authorization assertions, containing a concrete list of data, transactions, and so on that can be accessed.

In a pure Web-service environment, we would only need authorization assertions, but it will be some time before we reach that stage.

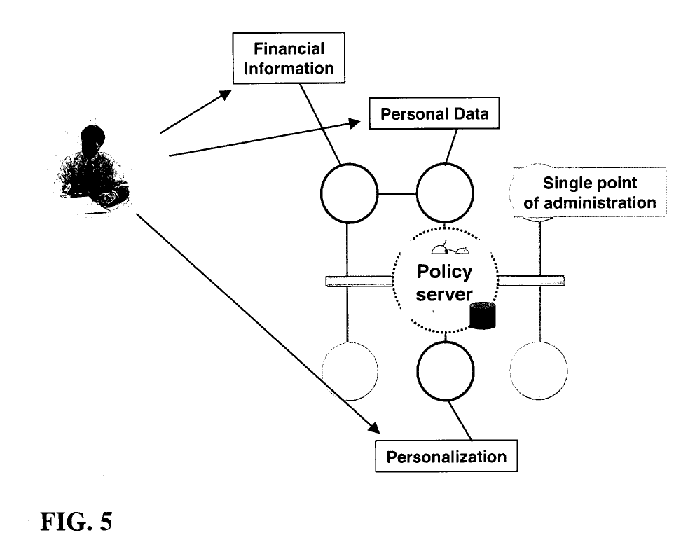

As illustrated by FIG. 5, distributed user/role data complicates the administration. It would be beneficial to have a transparent view on user data that is spread over different systems, allow for automated updates, etc.

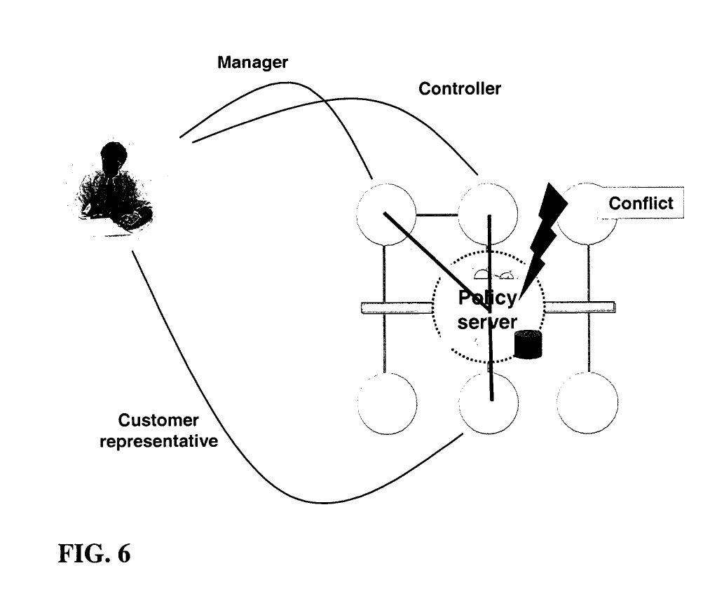

As shown in FIG. 6, consistency checks are clearly required. The management of a large number users might involve inconsistencies in roles/responsibilities; such inconsistencies should be automatically detected and indicated/resolved.

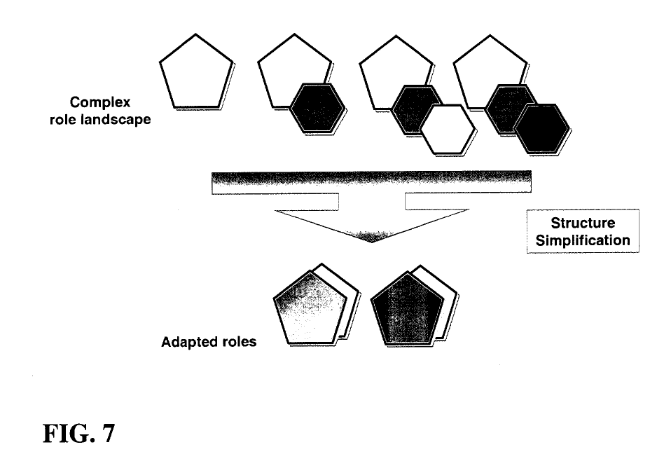

Administration of user bases means also granting/removing responsibilities/authorizations. Such a database evolves over time, as illustrated in FIG. 7 in the context of role mining, and it can be beneficial to introduce new roles/responsibilities that would introduce more structure to ease management. Such potential new roles/responsibilities could be automatically detected and indicated.

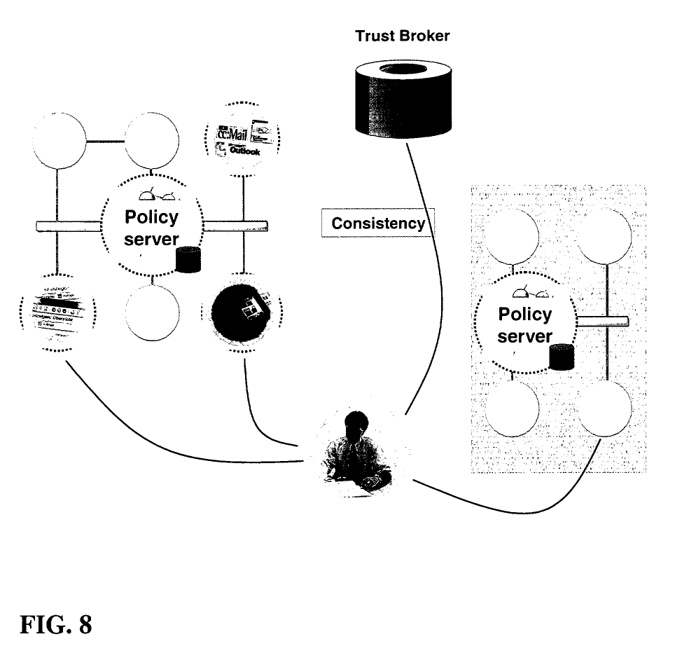

As shown in FIG. 8, external coordination is key. In the context of federations providing authentication and authorizations between systems and companies, the roles should be consistent among different tools and applications.

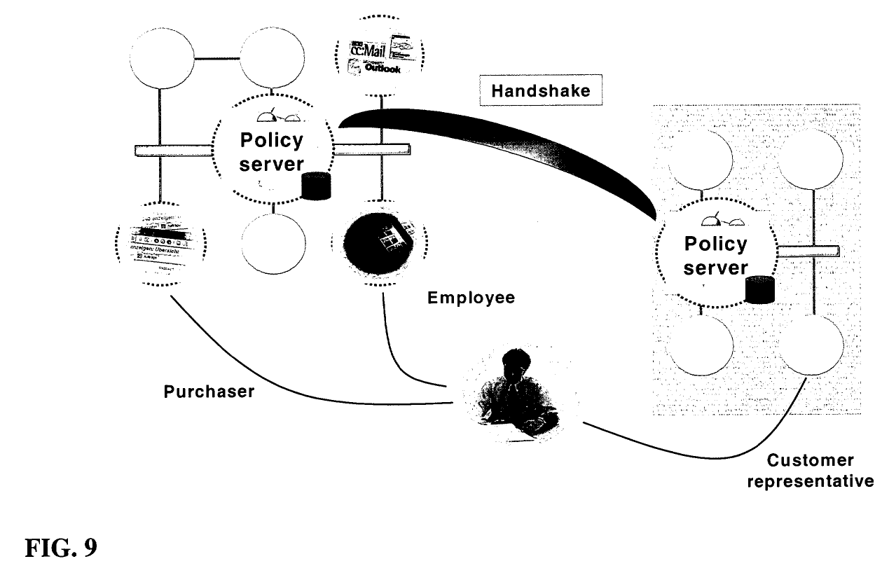

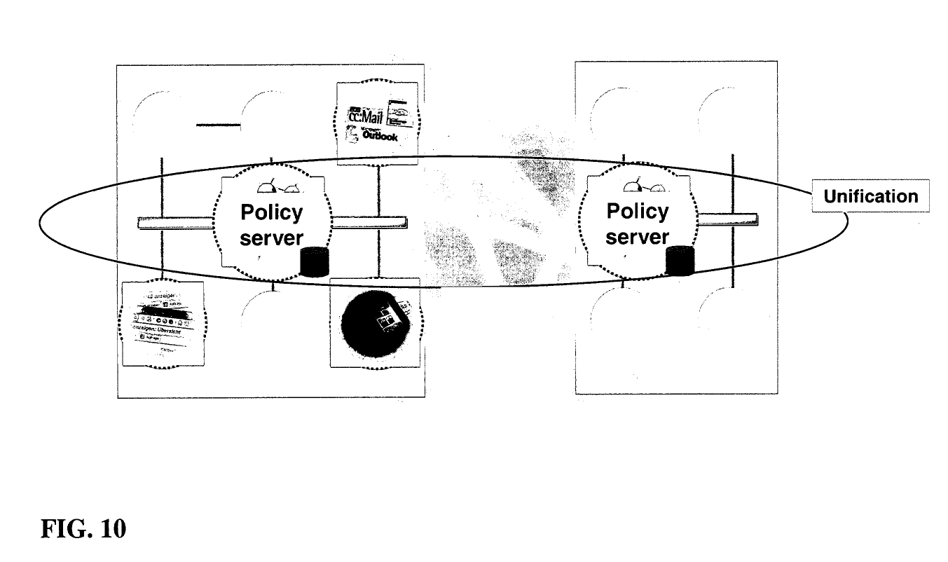

The role being defined in the master system, adequate projections of the role should be created and transported to the application systems, even across companies, according to previously established policies as illustrated for external mapping and projection in FIG. 9 Merging and consolidation are illustrated in FIG. 10. If two organizations are merged, the respective user management data needs to be merged and consolidated. Such a process is today very resource-intensive and would benefit from supporting tools.

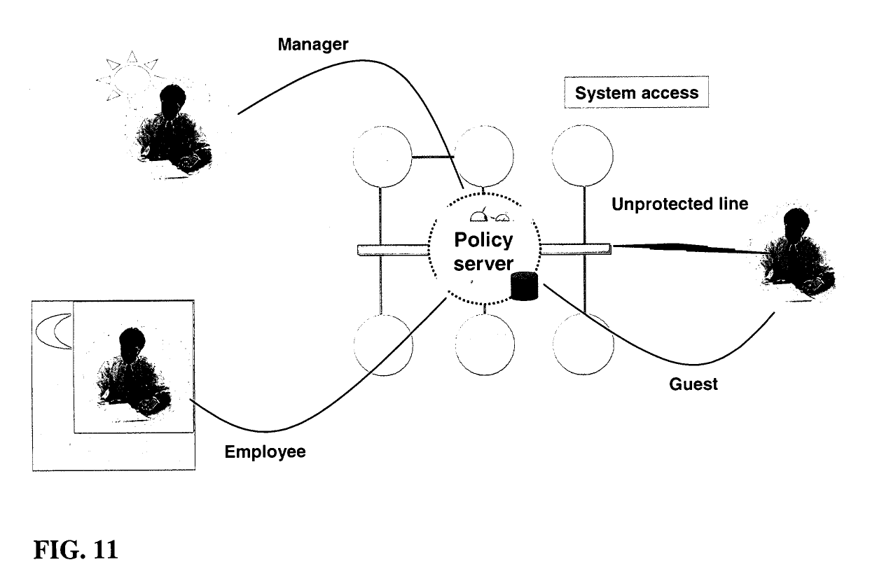

FIG. 11 illustrates the problem of differentiation and context. The users should get different authorizations depending on locality, time and authentication method.

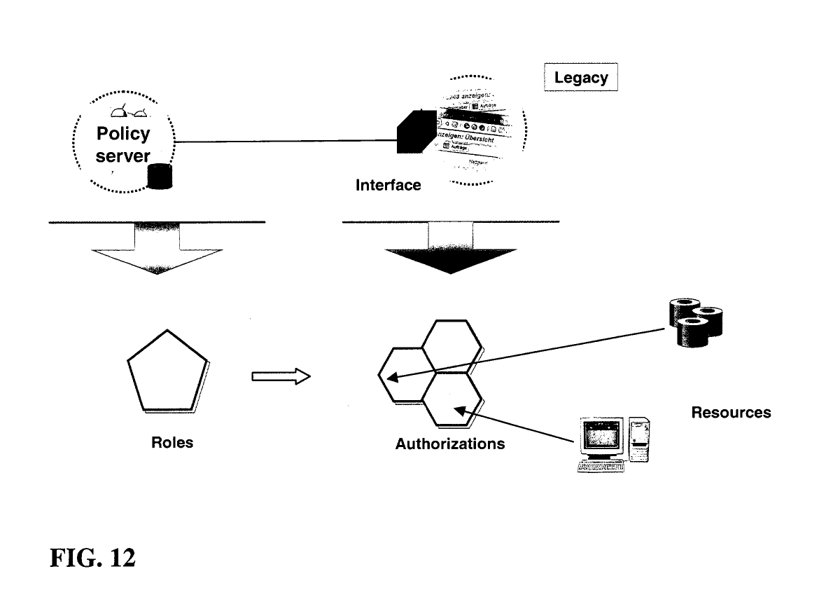

Separation of authority is illustrated in FIG. 12. The authorization on the service level should be performed by an external policy server, while the internal level of authorization should occur in the application itself. This requires a finding a sensible separation of duties, maybe roles, as opposite to responsibilities.

A number of embodiments of the invention have been described. Nevertheless, it will be understood that various modifications may be made without departing from the spirit and scope of the invention. For example, constraints and conditions can be built into the privilege sets, and the privilege sets can be hierarchical so that one privilege or set of privileges automatically implies another child set of privileges. In addition, role mapping can be combined with other security administration systems such as Kerberos or SAML. Accordingly, other embodiments are within the scope of the following claims.

What is claimed is:

1. A collaborative authorization process, comprising
defining a set of roles in a first system,
identifying a set of privileges corresponding to each of said roles in said first system,
establishing a mapping of each role to corresponding privileges in a second system, and
at runtime automatically granting access to a user according to privileges in the second system to which the user's role in the first system maps.

2. The process of claim 1, wherein said first and second systems are located within different enterprises, so that there is a mapping of roles to privileges between enterprises.

3. The process of claim 1, further comprising establishing a directory correlating the user ID with his or her role in the first system.

4. The process of claim 1, wherein privileges in the second system are aggregated in roles, so that by mapping each role in the first system to corresponding privileges in a second system, roles in the first system are mapped to corresponding roles in the second system.

5. The process of claim 3, wherein said first and second systems are located within different enterprises, so that there is a role mapping between enterprises.

6. A collaborative authorization process, comprising
defining a set of roles in a first enterprise,
identifying a set of privileges corresponding to each said role in said first enterprise,
establishing an mapping of the role to a corresponding role in a second enterprise having a corresponding set of privileges,
establishing a directory correlating the user ID with his or her role in the first enterprise, and
at runtime automatically granting access to the user based on privileges associated with the role in the second enterprise to which said role in the first enterprise maps.

7. A collaborative authorization process, comprising
mapping a set of roles in one system onto a set of roles in another system according to the equivalence of their respective privileges, to establish a role-mapping from one enterprise to the another,
when a user in one enterprise applies for authorization to gain access to a resource in the other system, identifying the user's role in said one system and using the pre-existing role-mapping to ascertain the corresponding role, with corresponding privileges in the other system, and then
based on the privileges conferred on the corresponding role in the other system, granting or denying the user access to the resource.

8. The process of claim 7, wherein mapping the roles is carried out by decomposing roles into their associated privileges,
establishing a common vocabulary to define the privileges in terms of resource access and any qualifying parameters as to the extent or conditions upon which access is granted,
identifying identical privileges mirrored between the two systems,
identifying equivalent privileges between the two systems,
aggregating the corresponding mirrored and equivalent privileges into sets of privileges corresponding to roles, and
identifying matching roles in the two systems based on the identity or equivalence of the privileges conferred on the roles.

9. The process of claim 8, wherein both systems share a common vocabulary for defining roles and privileges

10. The process of claims 7, 8 or 9, wherein the systems are within different enterprises.

11. The process of claims 7, 8 or 9, where in the systems are different enterprises.

12. A collaborative authorization process, comprising
defining a set of privileges in a first system,
establishing a mapping of each said set of privileges to corresponding roles in a second system, and
at runtime automatically granting access to a user according to privileges associated with the roles in the second system to which the user's set of privileges in the first system maps.

13. The process of claim 12, wherein said first and second systems are located within different enterprises, so that there is a mapping of roles to privileges between enterprises.

14. The process of claim 12, further comprising establishing a directory correlating the user ID with his or her privileges in the first system.

15. The process of claim 12, wherein privileges in the second system are aggregated in roles, so that by mapping each set of privileges in the first system to corresponding roles in a second system, privileges in the first system are mapped to corresponding sets of privileges in the second system.

16. The process of claim 15, wherein said first and second systems are located within different enterprises, so that there is a mapping of privileges between enterprises.
